(19) United States
(12) Patent Application Publication
(10) Pub. No.: US 2015/0121462 A1
(43) Pub. Date: Apr. 30, 2015

(54) IDENTITY APPLICATION PROGRAMMING INTERFACE

(71) Applicant: GOOGLE INC., Mountain View, CA (US)

(72) Inventors: Michael Roberts Courage, Redmond, WA (US); Sriram Saroop, Mountain View, CA (US)

(73) Assignee: GOOGLE INC., Mountain View, CA (US)

(21) Appl. No.: 14/062,063

(22) Filed: Oct. 24, 2013

(51) Int. Cl. H04L 29/06

(52) U.S. Cl. CPC H04L 63/08
USPC 726/4; 726/9

(57) ABSTRACT

A method includes receiving a packaged application's request for access to a user's cloud- or network-based account. The packaged application runs outside a web browser on a computing device. If there is an outstanding user consent to access by the packaged application to the user's cloud- or network-based account, the method includes returning an access token to the packaged application. The access token gives the packaged application access to the user's cloud- or network-based account. If there is no outstanding user consent to access by the packaged application to the user's cloud- or network-based account, the method includes presenting a web-based user consent dialog in a webview container in an identity component application installed on the computing device.

### TECHNICAL FIELD

This disclosure generally relates to applications for cloud computing devices.

### BACKGROUND

Cloud or network-based computing is a type of computing that relies on sharing computing resources over the web rather than relying on local resources (e.g., local servers or personal devices) to handle applications. Different services or resources (e.g., servers, storage, data and applications) can be delivered over the web to a user via a web browser. A user may have one or more accounts with cloud- or network-based service providers to avail of the different services or resources.

Generally, a web application (“web app”) is a program that is written in, for example, HTML5, JavaScript, and CSS, and is designed to be run entirely within a web browser on a user's computing device. Google Docs and Gmail are examples of cloud- or network-based web apps that are used or run entirely within a web browser tab.

A web app that can run entirely within the web browser may be either a “hosted web application” or a “packaged web application.” A hosted web application may be, for example, hosted on the Internet or other network, available as an URL, and accessed by users using a web browser. The hosted web application's components on the Internet may include, for example, a portion of a web site that itself may include one or more web pages and possibly some metadata that may be pertinent to a functionality of the web application. In contrast to the hosted web application, a packaged web application may be thought of as a web application all of whose components are bundled in a package that can be downloaded (e.g., from a public or private app store) for local execution by the web browser on the user's computing device. A packaged web application may be executed even when the user's computing device is offline i.e. without access to a network or the Internet.

Furthermore, “native” or “natively-operating” apps are apps that are developed to operate in their own application containers outside of a web browser on the user's computing device. A natively-operating app may interact with and take advantage of operating system features and other software that may be typically installed on user's computing device but are not available to web apps.

Like a packaged web app, a natively-operating app may also be bundled in a package that can be downloaded (e.g., from a public or private app store) for local installation and execution on the user's computing device. The packaged natively-operating app, like a packaged web application, may also be written in HTML5, JavaScript, and CSS. Both kinds of packaged apps can load the same type of content: HTML documents with CSS and JavaScript. However, in contrast to the within-browser operation of a packaged web app (or a hosted web app), a packaged natively-operating app is designed to be installed on the user's computing device and run outside of a browser tab directly from the computing device's hard drive.

Apps (either web apps or natively-operating apps) often require access to data or resources, which may be available in a user's cloud- or network-based account, for certain app functionalities. For example, a financial or accounting app may require access to user-owned financial data (e.g., bank balances, mortgage payments, etc.) stored in the user's cloud- or network-based account (“user account”).

For security, user approval or authorization may be required before granting the app (e.g., a third party app) access to the user-owned data in the user's cloud- or network-based account. Common web authorization protocols (e.g., OAuth 1.0 and OAuth 2.0) allow a user to grant a third-party web app (or web site) access to the user's data in the user's cloud- or network-based account, without having to reveal or share the user's account login credentials (e.g., password) with the web app. Once a web app is granted access by the user, the web app may receive an access token that the web app may use (instead of the user's account login credentials) to repeatedly to access the user-owned data in the user account.

Example implementations of web authorization protocols for granting web apps access to user data in the user's cloud- or network-based account may utilize web features such as HTTP elements, URL redirects and session cookies. While these web features may be suitable for or compatible with the operation of web apps, which run inside a web browser, they are not compatible with the operation of packaged natively-operating apps, which run outside a web browser; the packaged natively-operating apps do not load over HTTP and cannot perform redirects or set cookies.

A need exists for user approval or authorization procedures for granting access to user data in the user's cloud- or network-based accounts to packaged natively-operating applications.

### SUMMARY

For convenience in description and consistent with an evolving use of terms in the industry, the term “a packaged app” as used herein, in appropriate context, may be understood to refer to “a packaged natively-operating app” operating outside a web browser and not to “a packaged web app” operating inside a web browser.

A packaged app running outside a web browser on a user's computing device may request access to protected user data in a web account of the user. The request may be subject to user authentication and approval or consent.

In accordance with the principles of the disclosure herein, an identity application programming interface (API) may be configured to present a web-based user consent dialog embedded as an independent process in a user interface (UI) or window of the packaged app even as the packaged app runs its own process or processes outside a web browser on the user's computing device. The process of the embedded user consent dialog, which may be exclusively controlled by the identity API, may be fully isolated or sandboxed from the packaged app process or processes on the user's computing device. The embedded web-based user consent dialog process may not share session cookies or other user information with the packaged app process or processes.

In a general aspect, a method includes receiving an application's request for access to a user's network-based account. The application can be running as an application process or processes outside a web browser on a computing device. If there is an outstanding user consent to access by the application to the user's network-based account, the method includes returning an access token to the application, the access token enabling access to the user's network-based account. Conversely, if there is no outstanding user consent to access by the application to the user's network-based account, the method includes presenting a web-based user consent dialog embedded in a system-generated window on the computing device as a process that is independent of the application process or processes.

In a general aspect, a method involves getting user consent to provide access to an application to the user's network-based account. The application can be running outside a web browser on a computing device having a web OS and a computing device runtime that is a browser process. The method includes providing an identity application programming interface (API) on the computing device to the application to communicate with an identity provider, the identity API being configured to exchange a user login token with the identity provider in return for session cookies for a web-based user consent UI session. The method further includes providing an identity component application coupled to the identity provider through the identity API and configured to serve the user consent UI on the computing device.

In a general aspect, a non-transitory computer-readable storage medium has instructions stored thereon, which instructions when executed by one or more microprocessors cause a computer system to process an application's request for access to a user's network-based account, the application running as an application process or processes outside a web browser on a computing device. If there is an outstanding user consent to access by the application to the user's network-based account, the instructions cause the computer system to return an access token to the application, the access token enabling access to the user's network-based account. Conversely, if there is no outstanding user consent to access by the application to the user's network-based account, the instructions cause the computer system to present a web-based user consent dialog embedded in a system-generated window on the computing device as a process that is independent of the application process or processes.

In a general aspect, a non-transitory computer-readable storage medium has instructions stored thereon, which instructions when executed by one or more microprocessors cause a computer system to get a user consent to provide an application access to the user's network-based account. The application can be running outside a web browser on a computing device, the computing device having a web OS and a computing device runtime that is a browser process. The instructions cause the computer system to provide an identity application programming interface (API) in computing device runtime to the application for communication with an identity provider. The identity API is configured to exchange a user login token with the identity provider in return for session cookies for a web-based user consent user interface (UI) session. The instructions further cause the computer system to provide an identity component application coupled to the identity API and configured to serve the user-consent UI on the computing device.

In a general aspect, a computing device comprising includes at least one processor and at least one memory. The processor is to run an application installed in memory. The application can run an application process or processes in its own application container outside a web browser on the computing device. The computing device further includes an identity application program interface (API) configured to receive requests from the application in computing device runtime for access to the user's data or accounts and to forward such requests to an identity provider server configured to authenticate a user and authorize requests for access to the user's data or accounts based on user consent, and an identity component application coupled to the identity API. The identity component application is configured to present a web-based user consent dialog on the computing device as a process that is independent of the application process or processes.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic block diagram illustration of an example system, which is configured to obtain a user's approval or authorization for exposure of the user's data to a packaged application installed on a computing device, in accordance with the principles of the disclosure herein.

FIG. 2 is a schematic block diagram illustration of an example computing device runtime, which includes an Identity API that is configured to display web-based user consent dialogs for granting a packaged app access to user data or service accounts on network servers, in accordance with the principles of the disclosure herein.

FIG. 3 is an illustration of an example consent UI, which may be displayed inside a system-generated window (e.g., a webview container in an identity component application) on the computing device, for obtaining a user's consent to granting the packaged application access to protected user data, in accordance with the principles of the disclosure herein.

FIG. 4 is a flow diagram illustrating an example process for obtaining a user's approval or authorization for exposure of the user's data to a packaged application installed on a computing device, in accordance with the principles of the disclosure herein.

FIG. 5 is a flow chart illustrating an example method, which may be used to obtain user consent for exposing the user's data in the user's cloud- or network-based account to a packaged application, in accordance with the principles of the disclosure herein.

FIG. 6 is a flow chart illustrating another example method for getting a user's consent to provide a packaged application access to the user's cloud- or network-based account, in accordance with the principles of the disclosure herein.

FIG. 7 is a schematic illustration of a generic computer device and a generic mobile computer device, which may be used with the techniques described herein.

Like reference symbols in the various drawings indicate like elements.

### DETAILED DESCRIPTION

Just like web apps, packaged apps may be written in HTML5, JavaScript, and CSS. A packaged app, like any native app or web app, may need access to user data, which is protected in a user's cloud- or network-based account (“user's web account”), for certain tasks or activities. Token-based authentication and authorization protocols (e.g., OAuth 2.0) may govern the packaged app's access to user data in the user's web account. Implementation of the authentication and authorization protocols may involve an identity provider, which may be an authentication module on a server. A packaged app wanting to access the user's web account (e.g., Google+ API or GitHub API, etc.) may need the user to authenticate with the identity provider and to grant the packaged app access to the user's web account. Once the user has granted access, the packaged app may request an access token (e.g., an OAuth access token) from the identity provider that it can use, in lieu of explicit user authentication, to make API calls to the user's web account.

For user authentication, an Identity API supported by the identity provider may be configured to accept a logged-in-identity or log-in token of the user of the computing device as a security token for user authentication without requiring the user to enter a password or other credential. Further, the Identity API may be configured to let the packaged app request an access token (e.g., OAuth access token), which may allow the packaged app to make web service calls on behalf of the user to the user's web account. A range of resources made available and operations permitted in the user's web account by the access token may be controlled during the access token request process via a variable parameter called ‘scope’. Several scopes may be included in the access token request made by the packaged app.

A user consent dialog (or dialogs) may be employed to receive or process user input for user authentication and for user approval or grant of access scopes requested by a packaged app.

In accordance with the principles of the present disclosure, the identity API may be configured to serve the user consent dialog as URL content or a web page (“web page”) embedded in a system-generated window on the computing device even as the packaged app runs outside a web browser on the user's computing device. The embedded web page may be a process that is exclusively controlled by the identity provider/identity API. The embedded web page process may be fully isolated or sandboxed from the packaged app process or processes. The independence and isolation of the embedded web page process may preclude sharing of permissions, session cookies or other user information (which may be generated by the web-based user consent dialog) with the packaged app process or processes. For example, HTTP cookies, which may be used by the identity provider or identity API to save the user's login state or identity, may not be shared with or communicated to the packaged app process or processes.

Further, in accordance with the principles of the present disclosure, a packaged app/identity component application may be configured to receive and display URL content or web page (i.e. user consent dialog) served by the identity provider/identity API. The packaged app, which is coded to operate outside of a web browser, may include a coding construct that allows display of web content (e.g. the URL content or web page served by the identity provider/identity API) in a container in the packaged application UI or window. For an example chrome packaged app supported by the Chrome OS, such a coding construct may be a “webview” tag. The webview tag may generate a “webview” container embedded in the packaged app UI for displaying the URL content or web page therein. The webview tag may include the src of the URL content or web page and css styles that control the appearance of the webview container itself. It will be noted that while the css styles in the webview tag may control a look and feel of the webview container (e.g., container size) they may not control the displayed URL content or web page itself.

For convenience in description herein, display of URL content or a web page as an independent or isolated process embedded in a packaged app UI or window may be referred to as a “webview,” irrespective of whether the packaged app runs in Chrome OS or an operating system other than Chrome OS.

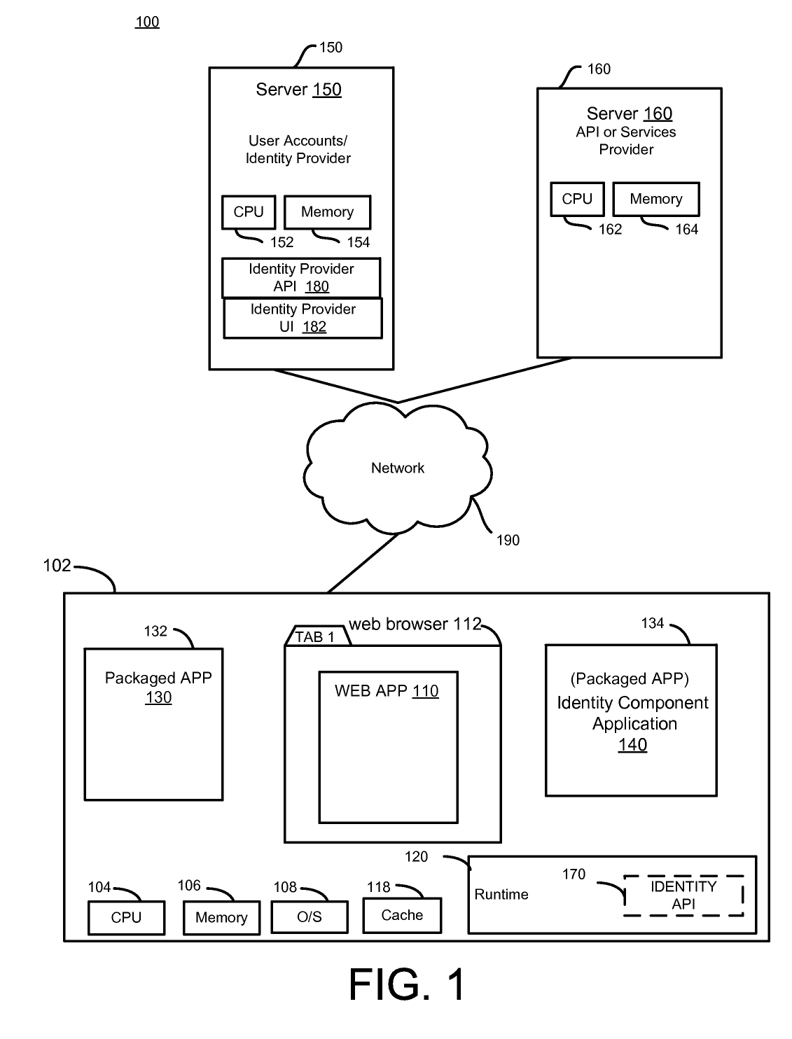

FIG. 1 is a schematic block diagram of an example system 100 that may be configured to provide authorization and authentication services to packaged applications for accessing protected user data in a user's cloud- or network-based accounts, in accordance with the principles of the disclosure herein.

In various implementations, system 100 may include one or more computing devices 102 (such as desktop computers, notebook computers, netbook computers, tablet computers, smart-phones, etc.). A computing device 102 may include one or more processors (e.g., CPU 104), one or more memories 106, an operating system (e.g., O/S 108), and a cache 118. O/S 108 may, for example, be a Chrome operating system or other native operating system (e.g., Windows, Linux, Unix or Mac OS X, etc.). Computing device 102 or O/S 108 may include or support a software or user interface (e.g., a browser or a system-specific client) through which computing device 102 can access applications and resources residing on the web. Computing device 102 may execute a runtime 120 and various applications (e.g., a web application 110, a packaged application 130, a packaged application/identity component application 140, etc.). Web application 110 may run in a tab of web browser 112, which may be provided by O/S 108. In contrast, packaged applications 130 and 140, which may installed on a hard drive or memory of computing device 102, may run outside of any web browser in their own application containers 132 and 134, respectively.

Computing device 102 may be linked via a network 190 to one or more servers hosting a user's cloud- or network-based accounts (e.g., User Accounts server 150, and API/services provider server 160). Server 150 and server 160 may each include one or more CPUs and memories (e.g., CPU 152/Memory 154, and CPU 162/Memory 164, respectively). The one or more servers (e.g., User Accounts server 150) may be configured to function as identity providers, for example, under a standard authentication and authorization protocol (e.g. OAuth 2.0) or other custom protocols.

Server 150 may, for example, include an identity provider API 180 coupled to an Identity UI 182. Identity provider API 180 may be configured to receive requests for authentication and authorization (e.g., from client devices such as computing device 102) to access protected user data on the servers. Identity provider API 180 may verify a security token as an alternative to explicitly authenticating a user (e.g., of computing device 102) and authorize requests to access protected user data or accounts on the servers (e.g., server 160). Identity provider UI 182 may be configured to act as an interface between identity provider API 180 and the client device (e.g., computing device 102).

A packaged app (e.g., packaged app 130) installed on computing device 102 may need access tokens to access protected user data, for example, in User Accounts server 150 or API/services provider server 160. User Accounts server 150 or API/services provider server 160 may provide access to the user data and accounts to packaged app 130 only if the user has authorized or consented to such access.

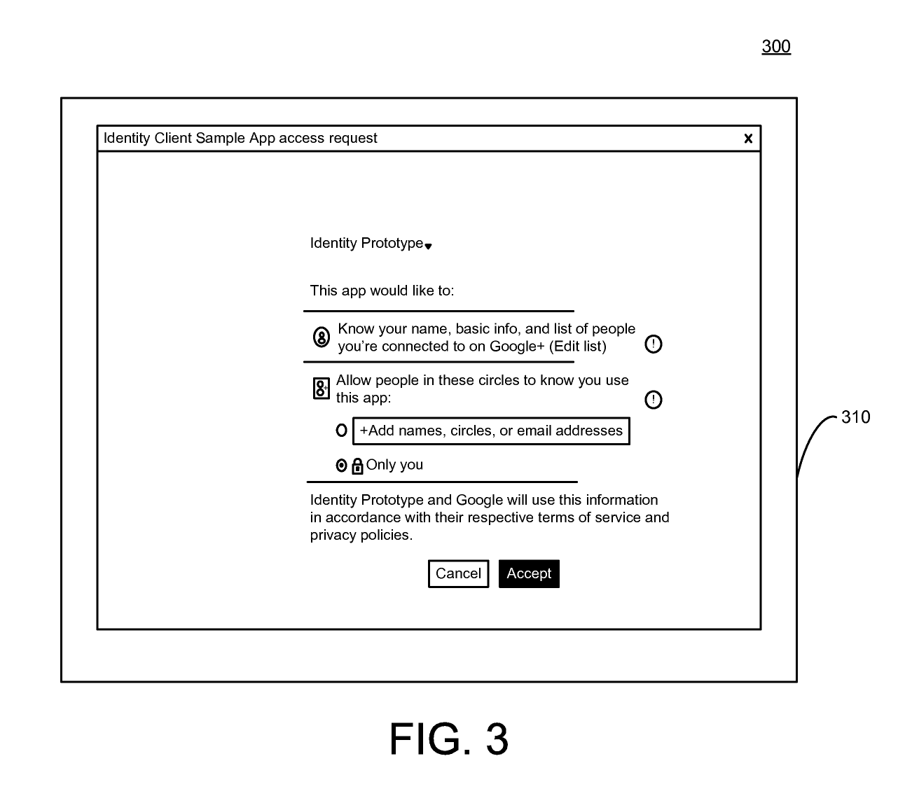

In accordance with the principles of the present disclosure, a client-side Identity API (e.g., Identity API 170) may be configured to interact with Identity provider API 180 on server 150 and serve web-based user consent dialogs (e.g., web-based consent UI 300, FIG. 3) on computing device 102 on which the packaged app (e.g., packaged application 130) operates outside of a web browser.

Identity API 170, which may be part of runtime 120 of computing device 120, may be configured to display the web-based consent UI on computing device 120. Identity API 170 may display the web-based consent UI in conjunction with an identity component application 140, which is also installed on computing device 120. In an implementation, the consent UI may be displayed in a webview container in identity component application 140, which may itself be a packaged application. In an alternate implementation, the consent UI may be visually attached to a display of packaged app 130 itself.

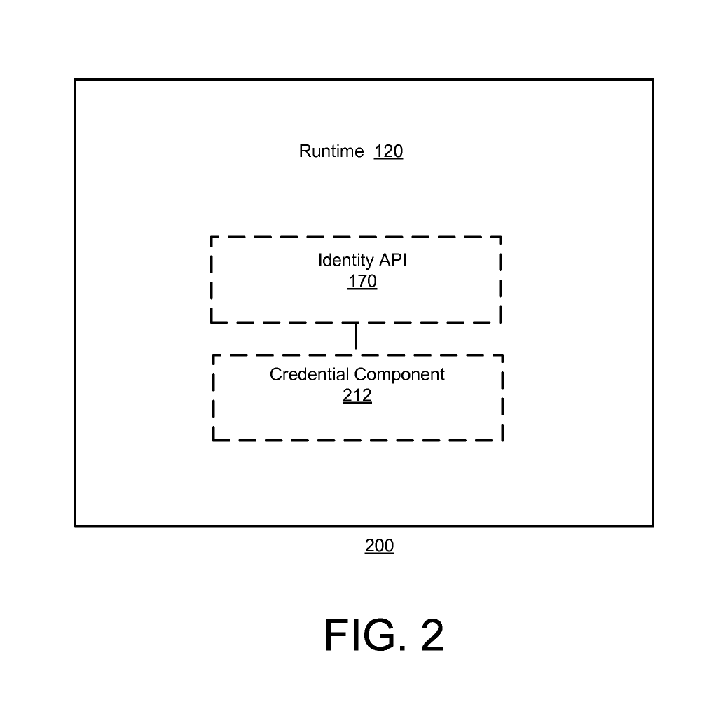

FIG. 2 schematically shows a structure of an example runtime 120, which includes Identity API 170 that is configured to display web-based user consent dialogs for granting a packaged app access to user data or service accounts on network servers, in accordance with the principles of the disclosure herein. Identity API 170 (which may comply with the OAuth 2.0 protocol or other token-based protocol) may be coupled in runtime 120 to a credentials handling system (e.g., credential component 212) that may generate, store, or retrieve the user's login credentials on computing device 102.

Generation of the web-based consent UI may be delegated by identity API 170 to an identity component application 140 (e.g., a JavaScript Chrome application) that is installed on computing device 102. Component application 140, which itself may be a packaged application that operates outside a web browser, may be configured to serve a webview of the web-based consent UI (e.g., consent UI 300). Implementing the consent UI with a component application (e.g., component application 140) may allow use of cookie partitioning features that are built into webview Control.

FIG. 3, shows an example consent UI 300, which may be displayed in a system generated window (e.g., a webview container 310 in an identity component application) on the computing device to obtain a user's consent for granting access to protected user data to the packaged application, in accordance with the principles of the disclosure herein.

In an example implementation, Identity API 170 may be configured so that token requests by a packaged application (e.g., packaged application 130) for access to user data or service accounts may be satisfied in one of three ways:
(1) From an in-memory access token cache (e.g., cache 118, FIG. 1).
(2) By an IssueToken call to an identity provider (e.g., identity provider API 180). This call may either return an access token (e.g., an OAuth token or other token) to the packaged application if the user has previously given consent, or may request that the user be prompted for consent.
(3) From a web-based UI flow (e.g., under an OAuth 2.0 protocol). The computing device runtime (e.g., runtime 120) may be configured to make a series of calls to exchange its user login access token or other token-based user credential (obtained from credential component 212) for session cookies, and to then invoke a web-based consent UI inside a webview container that is populated with the session cookies. It will be understood that exchange of user login access token for session cookies or credentials may take place under a protocol other than the OAuth 2.0 protocol

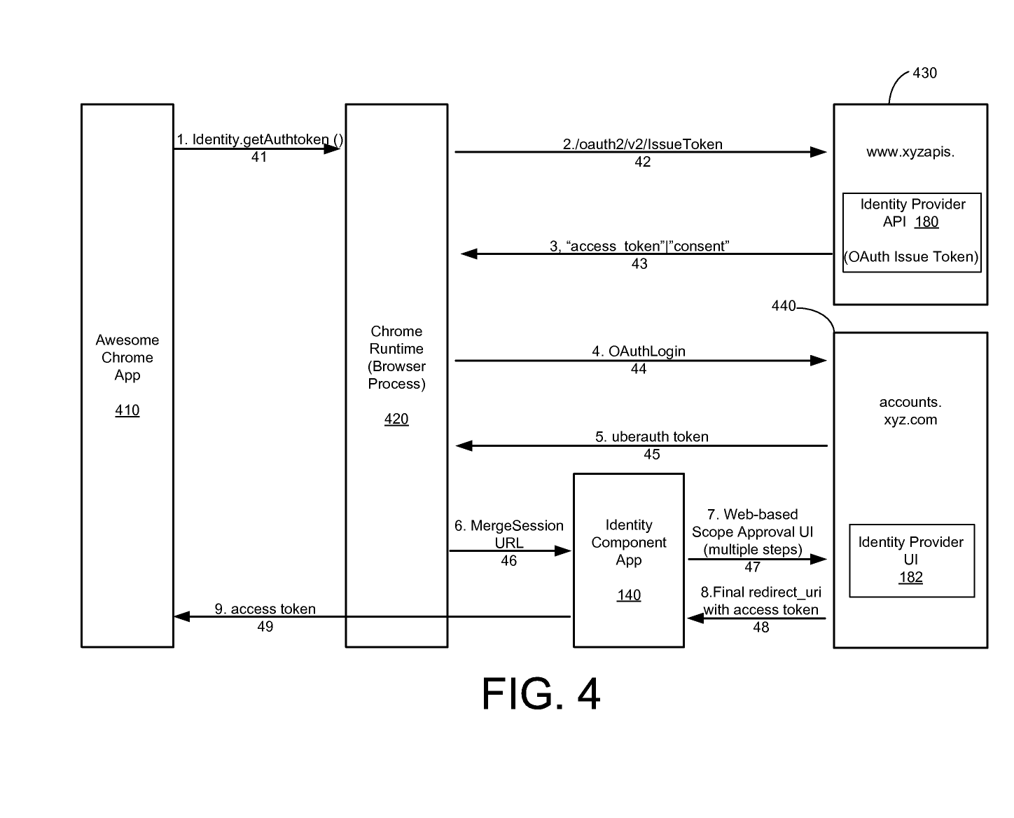

FIG. 4 is flow diagram which illustrates an example process 400 by which a Chrome packaged application 410 (e.g., Awesome Chrome App) can request an access token, in accordance with the principles of the disclosure herein. Process 400 may include displaying a web-consent UI (e.g., UI 300) to get the access token. It will be noted that some parts of process 400 (e.g., involving communications between identity component application 140 and identity provided UI 182) may comply with or involve standard authentication and authorization protocols (e.g., OAuth2.0 protocol) while other parts of process 400 may take place under a custom protocol other than the standard authentication and authorization protocols.

As shown in the figure, process 400 may involve interactions between packaged application 410 (e.g., Awesome Chrome App), Chrome runtime 420, which may be a browser process, an authorization provider server 430 (e.g., xyzapis.com which may include Identity provider API 180), an identity provider/user's service account server 440 (e.g., xyz.accounts.com, which may include Identity provider UI 182), and identity component application 140. It will be understood that servers 430 and 440, which are shown in FIG. 4, together may be logically equivalent to server 150, which includes both Identity provider API 180 and Identity provider UI 182 as shown in FIG. 1. Further, packaged application 410 may be registered with OAuth authorization service provider 430 to get its own client ID (e.g., OAuth2 client ID).

In process 400, packaged application 410 may issue an access token request (e.g., identity.GetAuthToken) to Chrome runtime 420 to get an access token to access the user's service account (e.g., at accounts. xyz.com) (41). Packaged application 410 may pass in its OAuth client ID and an array of scopes with the access token request to Chrome runtime 420. Chrome runtime 420 may then direct a call for the access token (e.g., oauth.v2.IssueToken) to Identity Provider API 180 at authorization provider server 430 (e.g., xyz.apis.com) using the user's credentials or token-based user credentials (42). OAuth authorization provider server 430 may return a response (43), which either includes the requested access token or an indication that user consent is required before the access token can be sent.

If the response includes the requested access token, the access token may be passed to packaged application 410 by Chrome runtime 420 (not shown). Packaged application 410 may then use the requested access token to accompany requests for account information (not shown) directed to, for example, user's service account server 440.

If the response indicates that user consent is required, in process 400, the next messages (e.g., 44-46) issued or received by runtime 420 may conform to an “exchange” protocol established with the Identity Provider to exchange token based-credentials for cookie-based credentials, which can be used in subsequent HTML- or web-based UI following, for example, the OAuth protocol. Under an example exchange protocol established with the Identity Provider, if the response indicates that user consent is required, Chrome runtime 420 may issue a call (44) (e.g., using an OAuthlogin string/OAuthLogin?issueuberauth=1) accompanied by the Chrome client ID and the user's login access token to identity provider/user's service account server 440. User's service account server 440 may respond by returning an uberauth token to Chrome runtime 420 (45). The uberauth token may allow Chrome runtime 420 to connect to any major cloud-service platforms using a simple interface while complying with, for example, either OAuth 1.0 or OAuth 2.0 standards.

Next, to set up a user consent dialog in webview, Chrome runtime 420 may send a MergeSession URL instruction (46) to identity component application 140. Identity component application 140 may then create a window containing a <webview>control (47), pointed at the MergeSession URL, with a continuation URL pointed to the OAuth authorization URL for Awesome Chrome App (e.g., (request type=token;redirect url=https://<awesome-chrome-app-id>.chromiumapp.org/oauth callback)). Identity component application 140 may present a web-based scope approval UI (e.g., UI 300) in <webview> on computing device 102. The presented web-based scope approval UI, may have multiple approval steps. The user may then proceed through the web-based approval flow displayed in <webview> to grant or authorize access. Identity component application 140 may intercept the redirect to chromiumapp.org and parse the redirect URL (48) to extract an access token (if present), before a final result (i.e., an access token or error) is returned to packaged application 410 (49).

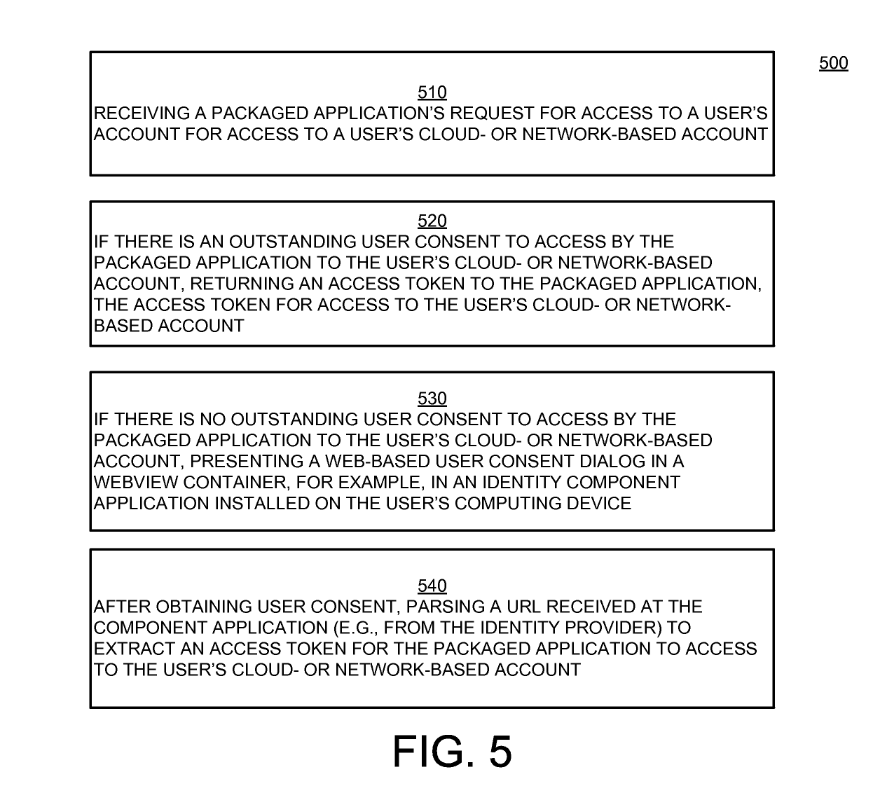

FIG. 5 shows an example method 500, which may be used to obtain user consent for exposing the user's data in the user's cloud- or network-based accounts to an application, in accordance with the principles of the disclosure herein. The application may be a packaged natively-operating application (e.g., packaged application 130) running outside a web browser on a computing device. The computing device may include a web OS (e.g., Chrome OS).

Method 500 may include receiving an application's request for access to a user's cloud- or network-based account (510). The application may be a packaged natively-operating application installed on the user's computing device. Receiving the application's request may involve providing an identity application programming interface (API) to receive and process the application's request.

If there is an outstanding user consent to access by the application to the user's cloud- or network-based account, method 500 may include returning an access token to the application, the access token enabling access to the user's cloud- or network-based account (520). Conversely, if there is no outstanding user consent to access by the application to the user's cloud- or network-based account, method 500 may include presenting a web-based user consent dialog in a webview container, for example, in an identity component application installed on the user's computing device (530). The web-based consent dialog may require that the user be logged in (e.g., in the computing device or the user's cloud- or network-based account) so that there is a valid login token, which the identity provider can use as a security token to authenticate the user. Further, presenting a web-based user consent dialog in a webview container in the application 520 may include having a component application of the identity API serve the user consent dialog in the webview container in the application. The user consent dialog served in the web container may be multiple step user consent dialog covering, for example, a request for varying scopes of authorizations.

Method 500 may also include, after obtaining user consent, parsing a URL received at the component application (e.g., from the identity provider) to extract an access token for the packaged application to access to the user's cloud- or network-based account (540).

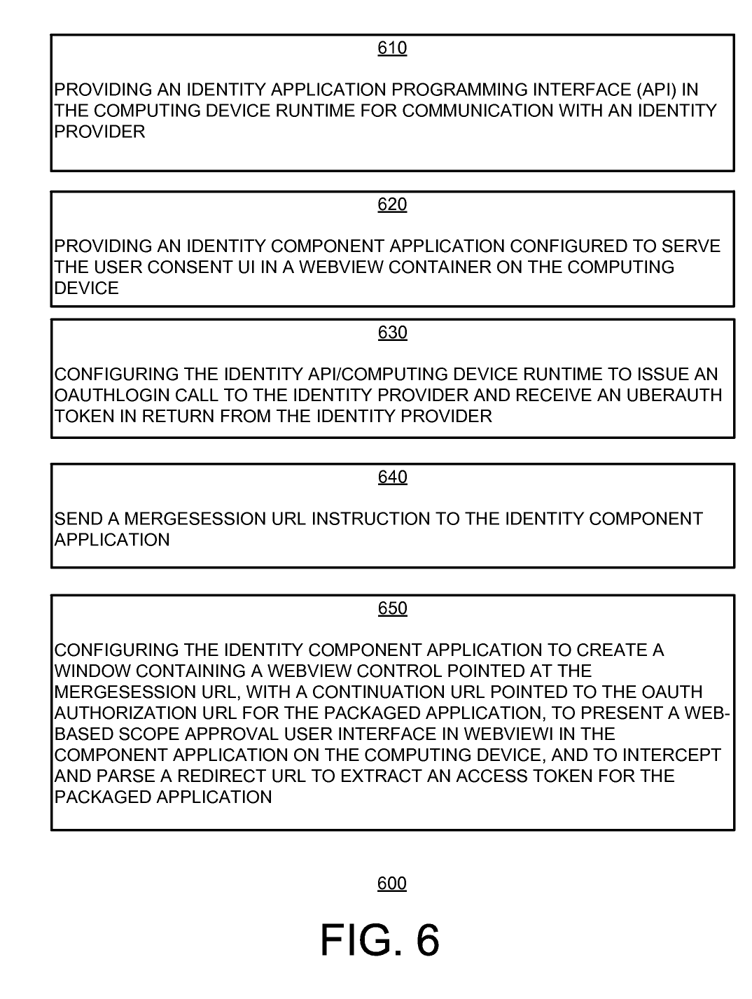

FIG. 6 shows another example method 600 for getting a user's consent to provide access to an application to the user's cloud- or network-based account, in accordance with the principles of the disclosure herein. The application may be a packaged application (e.g., packaged application 130) running outside a web browser on a computing device (e.g., computing device 120). The computing device may have a web OS and a computing device runtime that is a browser process.

Method 600 may include providing an identity application programming interface (API) in the computing device runtime for communication with an identity provider (610). Method 600 may further include providing an identity component application configured to serve a user consent UI in a webview container on the computing device (620). The identity API may be coupled to the identity component application, which may be another packaged application installed on the computing device.

The identity provider and identity API/computing device runtime may exchange messages with each other under a custom “exchange” protocol for translating token-based credentials into session cookie credentials. Method 600 may, for example, further include configuring the identity API/computing device runtime to issue an OAuthlogin call to the identity provider and receive an uberauth token in return from the identity provider (630), and send a MergeSession URL instruction to the identity component application (640).

With respect to the identity component application, method 600 includes configuring the identity component application to create a window containing a webview control pointed at the MergeSession URL, with a continuation URL pointed to the OAuth authorization URL for the application, to present a web-based scope approval UI or consent UI in webview in the component application on the computing device, and to intercept and parse a redirect URL to extract an access token for the application (650).

As noted earlier for method 500, method 600 also assumes that the user is logged in and that there is valid login token associated with a user profile for the identity provider to authenticate the user when the application runs. If for any reason there is no valid login token (e.g., the user may have revoked their login refresh token), then a sign-in dialog may be invoked to give the user an opportunity to login before the web-based scope approval dialog is presented in webview on computing device. The sign-in dialog may, for example, be presented as a sign-in screen in the web browser. After the sign-in dialog closes, the consent UI from the identity component application may open (if required) in webview.

A computer system may be deployed to practice process 400, method 500 or method 600 in conjunction with a non-transitory computer-readable storage medium having instructions stored thereon. The instructions when executed by one or more microprocessors may cause the computer system to obtain access tokens for an application (e.g., a packaged application) as described with reference to FIGS. 4-6.

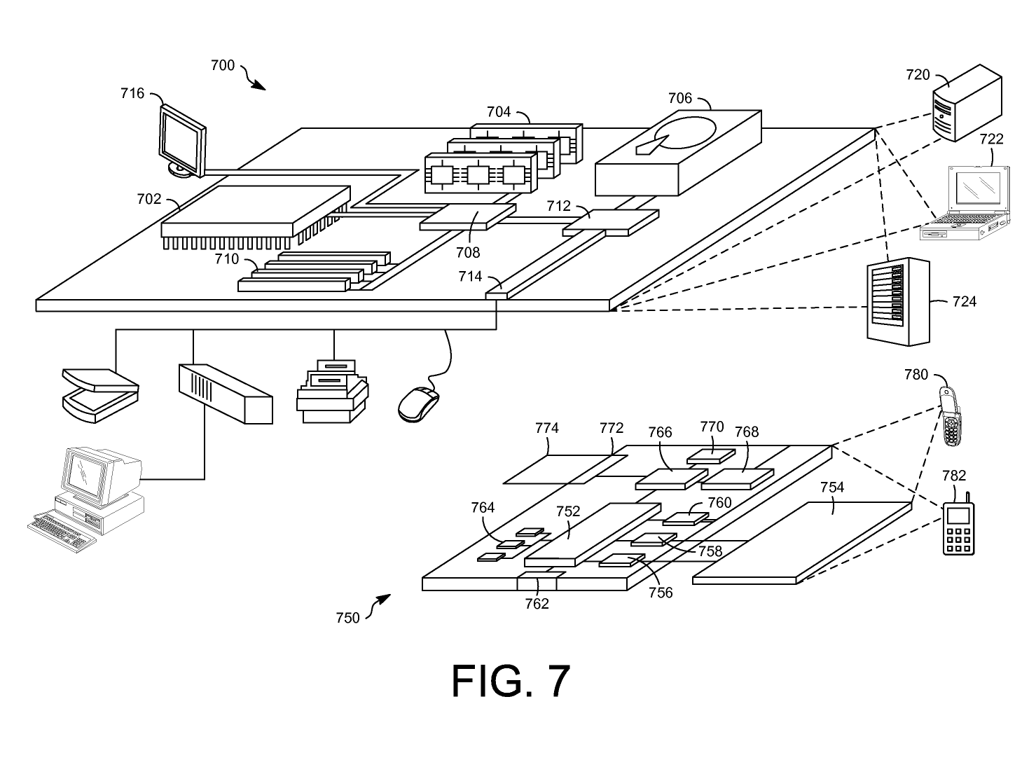

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, and an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosure herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method, comprising:
receiving an application's request for access to a user's network-based account, the application running as an application process or processes outside a web browser on a computing device;
if there is an outstanding user consent to access by the application to the user's network-based account, returning an access token to the application, the access token enabling access to the user's network-based account; and
if there is no outstanding user consent to access by the application to the user's network-based account, presenting a web-based user consent dialog embedded in a system-generated window on the computing device as a process that is independent of the application process or processes.

2. The method of claim 1, wherein the computing device on which the application is running includes a web OS.

3. The method of claim 1, wherein receiving an application's request for access to a user's network-based account includes processing the request at least in part according to a standard authentication and authorization protocol.

4. The method of claim 3, wherein the standard authentication and authorization protocol is the OAuth 2.0 protocol.

5. The method of claim 1, wherein the user consent dialog requires the user to be logged in to the user's network-based account.

6. The method of claim 1, wherein receiving an application's request for access to a user's network-based account includes:
providing an identity application programming interface (API) to receive the application's request.

7. The method of claim 6, wherein presenting a web-based user consent dialog embedded in a system-generated window on the computing device as a process that is independent of the application process or processes includes having a component application coupled to the identity API serve the user consent dialog in a webview container in the component application.

8. The method of claim 7, wherein having the component application of the Identity API serve the user consent dialog includes serving a multiple step user consent dialog.

9. The method of claim 7, further comprising:
after obtaining user consent, parsing a URL received at the component application to extract an access token for the application to access to the user's network-based account.

10. A method for getting a user consent to provide access to an application to the user's network-based account, the application running outside a web browser on a computing device having a web OS and a computing device runtime that is a browser process, the method comprising:
providing an identity application programming interface (API) on the computing device to the application to communicate with an identity provider, the identity API being configured to exchange a user login token with the identity provider in return for session cookies for a web-based user consent UI session; and
providing an identity component application coupled to the identity provider through the identity API and configured to serve the user consent UI on the computing device.

11. The method of claim 10, further comprises:
configuring the identity API to issue an OAuthlogin call in computing device runtime to the identity provider and receive an uberauth token in return from the identity provider.

12. The method of claim 11, further comprising:
configuring the computing device runtime to send a MergeSession URL instruction to the identity component application.

13. The method of claim 10, further comprising:
configuring the identity component application to create a window containing a webview control pointed at the MergeSession URL, with a continuation URL pointed to the OAuth authorization URL for the application.

14. The method of claim 13, further comprising:
configuring the identity component application to present a web-based scope approval user interface in webview in the identity component application.

15. The method of claim 14, further comprising:
configuring the identity component application to intercept and parse a redirect URL to extract an access token for the application.

16. A non-transitory computer-readable storage medium having instructions stored thereon, which instructions when executed by one or more microprocessors cause a computer system to:
process an application's request for access to a user's network-based account, the application running as an application process or processes outside a web browser on a computing device;
if there is an outstanding user consent to access by the application to the user's network-based account, return an access token to the application, the access token enabling access to the user's network-based account; and
if there is no outstanding user consent to access by the application to the user's network-based account, presenting a web-based user consent dialog embedded in a system-generated window on the computing device as a process that is independent of the application process or processes.

17. The non-transitory computer-readable storage medium of claim 16, wherein the computing device on which the application is running includes a web OS.

18. The non-transitory computer-readable storage medium of claim 16, wherein the instructions when executed by one or more microprocessors cause the computer system to:
process the application's request for access to the user's network-based account at least in part according to a standard authentication and authorization protocol.

19. The non-transitory computer-readable storage medium of claim 18, wherein the standard authentication and authorization protocol is the OAuth 2.0 protocol.

20. The non-transitory computer-readable storage medium of claim 16, wherein the user consent dialog requires the user to be logged in to the user's network-based account.

21. The non-transitory computer-readable storage medium of claim 16, wherein the instructions when executed by one or more microprocessors cause the computer system to:
provide an identity application programming interface (API) to receive the application's request.

22. The non-transitory computer-readable storage medium of claim 21, wherein the instructions when executed by one or more microprocessors cause the computer system to:
have a component application coupled to the identity API serve the user consent dialog having a component application coupled to the identity API serve the user consent dialog in a webview container in the component application.

23. The non-transitory computer-readable storage medium of claim 22, wherein the instructions when executed by one or more microprocessors cause the computer system to:
have the component application serve a multiple step user consent dialog.

24. The non-transitory computer-readable storage medium of claim 22, wherein the instructions when executed by one or more microprocessors cause the computer system to:
after obtaining user consent, have the component application coupled to the identity API parse a URL received at the component application to extract an access token for the application to access to the user's network-based account.

25. A non-transitory computer-readable storage medium for getting a user consent to provide an application access to the user's network-based account, the application running outside a web browser on a computing device, the computing device having a web OS and a computing device runtime that is a browser process, the non-transitory computer-readable storage medium having instructions stored thereon, which instructions when executed by one or more microprocessors cause a computer system to:
provide an identity application programming interface (API) in computing device runtime to the application for communication with an identity provider, the identity API being configured to exchange a user login token with the identity provider in return for session cookies for a web-based user consent user interface (UI) session; and
provide an identity component application coupled to the identity API and configured to serve the user-consent UI on the computing device.

26. The non-transitory computer-readable storage medium of claim 25, wherein the instructions when executed by one or more microprocessors cause the identity API to issue an OAuthlogin call in computing device runtime to the identity provider and receive an uberauth token in return from the identity provider.

27. The non-transitory computer-readable storage medium of claim 26, wherein the instructions when executed by one or more microprocessors cause the computing device runtime to send a MergeSession URL instruction to the identity component application.

28. The non-transitory computer-readable storage medium of claim 25, wherein the instructions when executed by one or more microprocessors cause the computing system to configure the identity component application to create a window containing a webview control pointed at the MergeSession URL, with a continuation URL pointed to the OAuth authorization URL for the application.

29. The non-transitory computer-readable storage medium of claim 25, wherein the instructions when executed by one or more microprocessors cause the computing system to configure the identity component application to present a web-based scope approval user interface in webview in the identity component application.

30. The non-transitory computer-readable storage medium of claim 25, wherein the instructions when executed by one or more microprocessors cause the computing system to configure the identity component application to intercept and parse a redirect URL to extract an access token for the application.

31. A computing device comprising:
at least one processor;
at least one memory, the processor configured to run an application installed in memory, the application running an application process or processes in its own application container outside a web browser on the computing device;
an identity application program interface (API) configured to receive requests from the application in computing device runtime for access to the user's data or accounts and to forward such requests to an identity provider server configured to authenticate a user and authorize requests for access to the user's data or accounts based on user consent; and
an identity component application coupled to the identity API, the identity component application configured to present a web-based user consent dialog on the computing device as a process that is independent of the application process or processes.

32. The computing device of claim 31, wherein the identity component application is configured to present the web-based user consent dialog on the computing device.

33. The computing device of claim 32, wherein the identity component application is configured to present the web-based user consent dialog in a webview container embedded in the window of the identity component application.

34. The computing device of claim 31, wherein the identity API is configured to exchange token-based user credentials with the identity provider server for cookie-based credentials.

35. The computing device claim 31, wherein the identity component application is further configured to intercept and parse a redirect URL to extract an access token for the application.
